(19) United States
(12) Patent Application Publication
(10) Pub. No.: US 2016/0005515 A1
(43) Pub. Date: Jan. 7, 2016

(54) CABLE ASSEMBLY CALIBRATION APPARATUS

(71) Applicant: Huawei Technologies Co., Ltd., Shenzhen (CN)

(72) Inventors: Na Wei, Shenzhen (CN); Xiongbiao Liu, Shenzhen (CN); Lei Bai, Shenzhen (CN)

(21) Appl. No.: 14/856,962

(22) Filed: Sep. 17, 2015

Related U.S. Application Data
(63) Continuation of application No. PCT/CN2014/071965, filed on Feb. 11, 2014.

(30) Foreign Application Priority Data
Aug. 14, 2013 (CN) 201310351956.1

(51) Int. Cl. H01B 13/00; H01R 25/00; H01R 43/16; H01B 7/40

(52) U.S. Cl. CPC H01B 13/0036; H01B 7/40; H01R 25/00; H01R 43/16

(57) ABSTRACT

A cable assembly calibration apparatus includes multiple cables and connectors placed at two end sides of the cables; the cable assembly calibration apparatus includes a calibration block and a calibration board that can perform calibration and positioning on the cable assembly in both an X direction and a Y direction; the calibration block is disposed at one end side, provided with the connector, of the cable assembly, and the calibration board is disposed at the other end side, opposite to the calibration block, of the cable assembly; and a convex structure or a concave structure is disposed on all surfaces, opposite to the cable assembly, of the calibration block and the calibration board, and the convex structure or the concave structure fits a calibration feature on the cable assembly to fasten the cable assembly.

### CROSS-REFERENCE TO RELATED APPLICATIONS

This application is a continuation of International Application No. PCT/CN2014/071965, filed on Feb. 11, 2014, which claims priority to Chinese Patent Application No. 201310351956.1, filed on Aug. 14, 2013, both of which are hereby incorporated by reference in their entireties.

### TECHNICAL FIELD

The present invention relates to the field of communications accessory technologies, and in particular, to a cable assembly calibration apparatus.

### BACKGROUND

In an existing communications device, for example, a switch, the chassis generally uses a cubic orthogonal architecture, and multiple layers of transversely inserted boards are disposed inside the chassis. The transversely inserted board is electrically connected to a connector at one end of a cable assembly, and a connector at the other end of the cable assembly is electrically connected to a vertically inserted board, thereby implementing high-speed signal interconnection between the transversely inserted board and the vertically inserted board by using the cable assembly. The cable assembly is of an elongated type in most cases and installed and fastened on a housing of the chassis. Generally, the vertically inserted board includes a high-speed signal, a low-speed signal, and a power connector. Therefore, assembly fitting between the vertically inserted board and both a backplane of another type and the cable assembly needs to be ensured, which are equivalent to two standards; as a result, alignment and assembly cannot be implemented easily.

Specifically, the cable assembly refers to an electrical product that integrates electrical connectors and cables, where the electrical connectors are electrically connected to a communications device and an instrument, and the electrical connectors are connected by using the cables, so that an electrical connection between the communications device and the instrument is implemented by using the cable assembly, so as to transmit a high-speed signal. In the prior art, the electrical connection between the communications device and the instrument may also be implemented by using a printed circuit board, but compared with the cable assembly, the cable assembly can shorten a length of a link (an electrical circuit between two adjacent nodes), and can ensure high-speed transmission of the signal. Therefore, practicability is relatively high.

However, a cable assembly is obtained by processing one whole mechanical part, and the cable assembly is a metalworking mechanical part. Therefore, processing and assembly precision of the cable assembly is lower than that of a printed circuit board, causing complex and difficult processing and assembly operations of the cable assembly. Particularly, in a large-capacity communications system, a cable assembly is also relatively large, and the precision problem of the cable assembly is especially prominent.

### SUMMARY

Embodiments of the present invention provide a cable assembly calibration apparatus, so as to improve assembly precision of a cable assembly, thereby improving assembly efficiency of the cable assembly.

To achieve the foregoing objective, the following technical solutions are used in the embodiments of the present invention:

According to a first aspect of the present invention, a cable assembly calibration apparatus is configured to calibrate at least two cable assemblies, where the cable assembly includes multiple cables and connectors placed at two end sides of the cables; the cable assembly calibration apparatus includes a calibration block and a calibration board that can perform calibration and positioning on the cable assembly in both an X direction and a Y direction; the calibration block is disposed at one end side, provided with the connector, of the cable assembly, and the calibration board is disposed at the other end side, opposite to the calibration block, of the cable assembly; and a convex structure or a concave structure is disposed on all surfaces, opposite to the cable assembly, of the calibration block and the calibration board, and the convex structure or the concave structure fits a calibration feature on the cable assembly to fasten the cable assembly.

In a first possible implementation manner of the first aspect, the calibration block includes multiple first calibration bars and at least one second calibration bar; and the first calibration bar fastens the cable assembly in the X direction, and the second calibration bar fastens the cable assembly in the Y direction.

With reference to the first possible implementation manner, in a second possible implementation manner, both the first calibration bar and the second calibration bar include at least one cuboid stick, and the convex structure or the concave structure is disposed on the cuboid stick.

With reference to the second possible implementation manner, in a third possible implementation manner, a first concave structure is disposed on the first calibration bar, and correspondingly, a first convex structure matching the first concave structure is disposed on the cable assembly; and a second concave structure is disposed on the second calibration bar, and correspondingly, a second convex structure matching the second concave structure is disposed on the cable assembly.

With reference to the third possible implementation manner, in a fourth possible implementation manner, the first concave structure is a square groove, the groove is conducted in a vertical direction of the cable assembly, correspondingly, the first convex structure is a square bump, and the square groove closely fits the square bump; and the second concave structure is a first pin hole, and correspondingly, the second convex structure is a first circular pin structure closely fitting the first pin hole.

In a fifth possible implementation manner of the first aspect, the calibration board is a tabular structure with an opening, and multiple rows of third concave structures and at least one row of fourth concave structure are disposed on the calibration board; correspondingly, a third convex structure matching both the third concave structure and the fourth concave structure is disposed on the cable assembly; and the third concave structure and the fourth concave structure are arranged in a matrix form; and the third concave structure can fasten the cable assembly in the X direction, and the fourth concave structure can fasten the cable assembly in the Y direction.

With reference to the fifth possible implementation manner, in a sixth possible implementation manner, multiple rows of third convex structures arranged in a matrix form is disposed on the calibration board, correspondingly, a guide sleeve is disposed on the cable assembly, and multiple rows of the third concave structures and at least one row of the fourth concave structure that closely fit the third convex structure are disposed on the guide sleeve.

With reference to the sixth possible implementation manner, in a seventh possible implementation manner, the third convex structure is a second circular pin structure, the fourth concave structure is a second pin hole, and a gap exists between the second pin hole and the second circular pin in the Y direction of the cable assembly; and the fourth concave structure is a third pin hole closely fitting the second circular pin.

The cable assembly calibration apparatus provided by the embodiments of the present invention includes a calibration block and a calibration board, where a convex structure or a concave structure for fastening a cable assembly is disposed on both the calibration block and the calibration board, and the cable assembly can be well fastened in an X direction and a Y direction by separately disposing the calibration block and the calibration board at two end sides of the cable assembly, so that when a transversely inserted board and a vertically inserted board are installed and fastened on the cable assembly, it can be ensured that the transversely inserted board and the vertically inserted board can be smoothly aligned and installed, thereby improving assembly precision of the cable assembly, and also improving assembly efficiency of the cable assembly.

### BRIEF DESCRIPTION OF THE DRAWINGS

To describe the technical solutions in the embodiments of the present invention more clearly, the following briefly introduces the accompanying drawings required for describing the embodiments or the prior art.

FIG. 1a is a schematic simplified diagram of a perspective of an assembly structure of a cable assembly calibration apparatus according to an embodiment of the present invention;

FIG. 1b is a schematic simplified diagram of another perspective of an assembly structure of a cable assembly calibration apparatus according to an embodiment of the present invention;

FIG. 2 is a schematic enlarged structural diagram after a pin matches a pin hole according to an embodiment of the present invention;

FIG. 3 is a schematic structural diagram after a calibration block matches a cable assembly according to an embodiment of the present invention;

FIG. 4 is a schematic structural diagram of a calibration block according to an embodiment of the present invention;

FIG. 5 is a schematic structural diagram of a calibration board according to an embodiment of the present invention; and

FIG. 6 is another schematic enlarged structural diagram after a pin matches a pin hole according to an embodiment of the present invention.

### DETAILED DESCRIPTION

The following clearly describes the technical solutions in the embodiments of the present invention with reference to the accompanying drawings in the embodiments of the present invention.

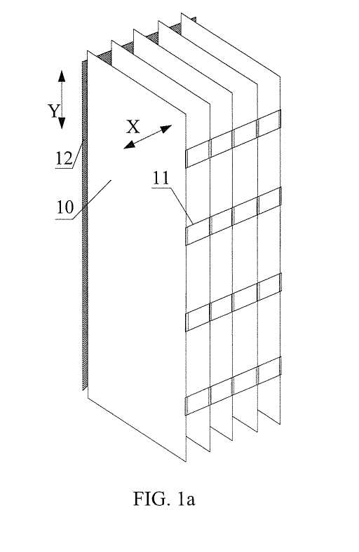

An embodiment of the present invention provides a cable assembly calibration apparatus, configured to calibrate at least two cable assemblies, where the cable assembly includes multiple cables and connectors placed at two end sides of the cables; as shown in FIG. 1a and FIG. 1b, the cable assembly calibration apparatus includes a calibration block 11 and a calibration board 12 that can perform calibration and positioning on the cable assembly in both an X direction and a Y direction; the calibration block 11 is disposed at one end side, provided with the connector, of the cable assembly 10, and the calibration board 12 is disposed at the other end side, opposite to the calibration block 11, of the cable assembly 10; and a convex structure or a concave structure is disposed on all surfaces, opposite to the cable assembly, of the calibration block 11 and the calibration board 12; and the convex structure or the concave structure fits a calibration feature on the cable assembly 11 to fasten the cable assembly 10.

The cable assembly calibration apparatus provided by this embodiment of the present invention includes a calibration block and a calibration board, where a convex structure or a concave structure for fastening a cable assembly is disposed on both the calibration block and the calibration board, and the cable assembly can be well fastened in an X direction and a Y direction by disposing the calibration block and the calibration board at two end sides of the cable assembly separately, so that when a transversely inserted board and a vertically inserted board are installed and fastened on the cable assembly, it can be ensured that the transversely inserted board and the vertically inserted board can be smoothly aligned and installed, thereby improving assembly precision of the cable assembly, and also improving assembly efficiency of the cable assembly.

It should be noted herein that, according to the convex structure or the concave structure on the calibration block and the calibration board, a person skilled in the art easily learns through analysis that correspondingly, a concave structure or a convex structure matching the convex structure or the concave structure on the calibration block and the calibration board needs to be disposed on the cable assembly, to complete calibration and positioning on the cable assembly. In addition, because the cable assembly is applied to a relatively large electronic device, for example, a switch, a volume of the cable assembly is also relatively large. Therefore, when calibration and positioning are performed for assembly, a manner of performing calibration and positioning on both two end sides of the cable assembly is used, to achieve a better calibration effect and high practicability.

The X direction is a direction shown in FIG. 1a and FIG. 1b, that is, a direction perpendicular to extension of the cable assembly; and the Y direction is a direction shown in FIG. 1a and FIG. 1b, that is, an extension direction of the cable assembly.

Specifically, as shown in FIG. 1, the calibration block 11 may include multiple first calibration modules and at least one second calibration module, where the first calibration module can perform calibration and positioning on the cable assembly 10 in a horizontal direction, and the second calibration module can perform calibration and positioning on the cable assembly 10 in a vertical direction. The calibration block 11 is disposed at one end side of the cable assembly 10, and the end side is generally connected to the transversely inserted board. Merely for a situation in which the transversely inserted board is installed on the cable assembly 10, the cable assembly 10 needs to be positioned in the horizontal direction and the vertical direction. The at least one second calibration module in the calibration block 11 is needed to complete the positioning in the vertical direction, and other first calibration modules in the calibration block 11 can perform calibration and positioning on the cable assembly 10 in the horizontal direction, and the second calibration module that performs calibration and positioning in the vertical direction can also perform calibration and positioning on the cable assembly 10 in the horizontal direction. Generally, using one second calibration module to position the cable assembly 10 in the vertical direction can meet the requirement. When multiple second calibration modules are used to position the cable assembly 10 in the vertical direction at the same time, over positioning and over constraint are easily caused to the cable assembly 10; as a result, other first calibration modules cannot complete calibration and positioning correctly.

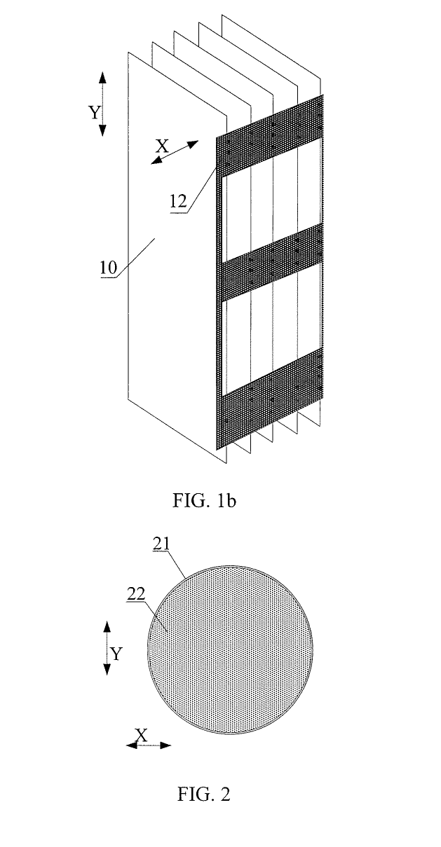

As shown in FIG. 2, a second concave structure may be disposed on the second calibration module that performs calibration and positioning on the cable assembly 10 in the vertical direction, and is a pin hole 21; and correspondingly, a second convex structure is disposed on the cable assembly 10, and is a circular pin 22 that can be closely assembled with and fit the pin hole 21. The pin hole 21 closely fits the pin 22, that is, a surface of an inner wall of the pin hole 21 is in close contact with an outer surface of the pin 22, so that the pin hole 21 can limit displacement of the pin 22 in the vertical direction, so as to complete calibration and positioning on the cable assembly 10 in the vertical direction. In FIG. 2, the pin may also be a square pin or a pin of another shape, and correspondingly, the pin hole 21 is a square pin hole or a pin hole of another matching shape.

For the structure shown in FIG. 2, it only needs to process and form the pin hole 21 on the second calibration module, and process and form the pin 22 on the cable assembly, which facilitate manufacturing and forming. When there is a pin structure on the second calibration module, a guide sleeve or another module needs to be disposed at a corresponding position of the cable assembly 10, and a pin hole structure closely fitting the pin is disposed on the guide sleeve, so as to complete calibration and positioning on the cable assembly in the vertical direction.

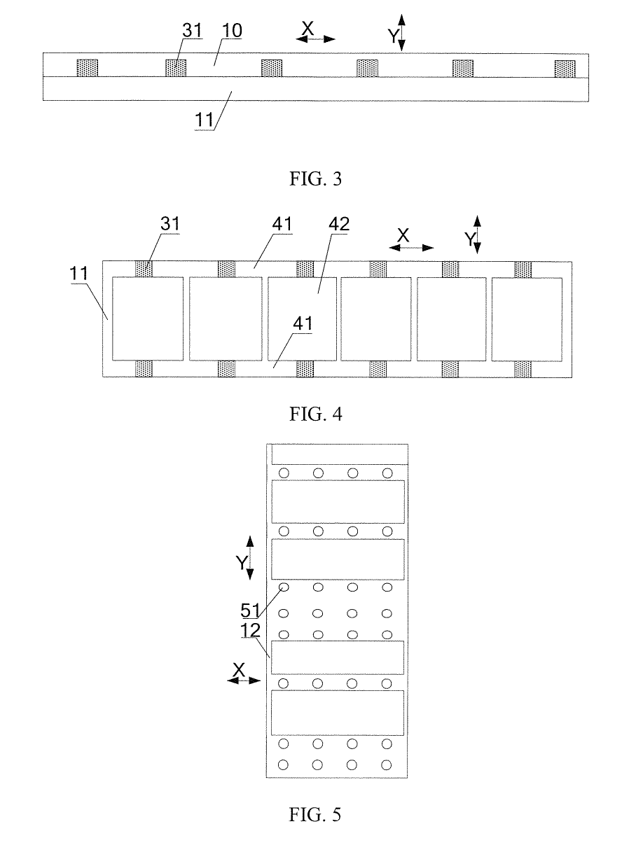

A first concave structure may be disposed on the first calibration module configured to calibrate the cable assembly 10 in the horizontal direction, and is a square groove, and correspondingly, a first convex structure disposed on the cable assembly 10 is a square bump. In this case, the groove is conducted in the vertical direction of the cable assembly 10, and a gap exists between two side walls in the horizontal direction, where the gap is used to place the square bump. As shown in FIG. 3, the square bump 31 is placed in the groove, and the groove can limit a position of the square bump 31 in the horizontal direction, so as to complete calibration and positioning on the cable assembly 10 in the horizontal direction. The section of the square bump 31 may be square, circular or another structure.

During specific implementation, as shown in FIG. 4, the first calibration module and the second calibration module may be formed by at least one calibration bar 41, and the convex structure or the concave structure is disposed on the calibration bar 41. FIG. 3 shows a structure that the first calibration module includes two calibration bars 41. The two calibration bars 41 are disposed in parallel, and are integrally connected, so that a first calibration module with multiple openings 42 can be formed between the two calibration bars 41, and the opening 42 corresponds to an interface of a connector on the transversely inserted board. In FIG. 3 and FIG. 4, that a square groove is disposed on the calibration bar 41 of the first calibration module, and correspondingly, the square bump 31 is disposed on the cable assembly 10 is used as an example.

In the cable assembly calibration apparatus described in the foregoing embodiments, as shown in FIG. 5, multiple rows of third concave structures and at least one row of fourth concave structure may be disposed on the calibration board 12; correspondingly, a third convex structure matching both the third concave structure and the fourth concave structure is disposed on the cable assembly 10; and the third concave structure and the fourth concave structure are arranged in a matrix form; and the third concave structure can perform calibration and positioning on the cable assembly 10 in the horizontal direction, and the fourth concave structure can perform calibration and positioning on the cable assembly 10 in the vertical direction.

It should be noted that, space needs to be reserved on the calibration board 12 for installing a component such as a vertically inserted board, and therefore, the third concave structure and the fourth concave structure are arranged at intervals, but are arranged in a matrix form in a whole structure.

After the calibration block 11 completes calibration and positioning on one end of the cable assembly 10, generally, a vertically inserted board needs to be installed on the other end of the cable assembly 10, so as to complete high-speed signal interconnection between the transversely inserted board and the vertically inserted board by using the cable assembly 10. Because the strength of the whole structure of the cable assembly 10 is relatively small, calibration and positioning on one end by the calibration block 11 cannot ensure assembly precision of the other end of the cable assembly 10. In this case, the calibration board 12 disposed at the other end of the cable assembly 10 needs to be used to perform calibration and positioning. Convex structures or concave structures may be disposed on the calibration board 12, and may be staggered horizontally and vertically, which facilitates calibration and positioning operations. Same as a calibration principle of the calibration block 11, at least one row of convex structure or concave structure in the horizontal direction of the cable assembly 10 can be aligned to perform calibration and positioning in the vertical direction (generally, calibration and positioning in the horizontal direction is also performed), and the rest is calibration and positioning in the horizontal direction, and same as a calibration and positioning principle of performing, by the calibration block 11, calibration in the vertical direction, generally, using one row of convex structure or concave structure on the calibration board 12 can meet the calibration requirement.

Specifically, the calibration board 12 may include multiple third concave structures and at least one fourth concave structure, and the third concave structure and the fourth concave structure respectively position the cable assembly in the horizontal direction and position the cable assembly in the vertical direction. Correspondingly, a third convex structure matching the third concave structure and the fourth concave structure is disposed on the cable assembly 10.

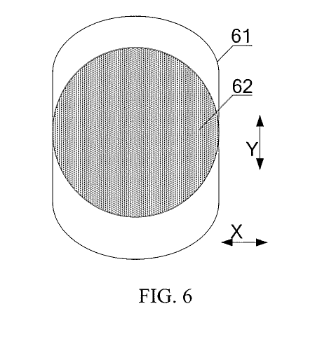

As shown in FIG. 5, a concave structure, on the calibration board 12, that performs calibration and positioning on the cable assembly 10 in the vertical direction may be a third pin hole 51, a second circular pin closely fitting the third pin hole 51 is disposed on the cable assembly, and a fitting manner of the second circular pin and the third pin hole 51 may be the manner shown in FIG. 2. The concave structure, on the calibration board 12, that performs calibration and positioning on the cable assembly 10 in the horizontal direction may be a second pin hole, but in this case, as shown in FIG. 6, the second pin hole 61 is a waist-circle-shaped structure, and a gap between an inner surface of a waist and an outer surface of the second circular pin 62 on the cable assembly placed in the second pin hole 61 is very small, which is used for performing calibration and positioning on the cable assembly in the horizontal direction. However, in the vertical direction, a gap between an upper end of the second pin hole 61 and the second circular pin 62 and a gap between a lower end of the second pin hole 61 and the second circular pin 62 are relatively large, and the gaps can be used for size tolerance in the vertical direction, so that the second circular pin 62 can match the second pin hole 61 more smoothly and better. Certainly, the third convex structure may also be a pin structure of another shape, such as a square or a cone.

When there is the third convex structure on the calibration board, a guide sleeve needs to be disposed on the cable assembly 10, and a third concave structure and a fourth concave structure that match the third convex structure are disposed on the guide sleeve. By comparison, a manner that there is a convex structure on the cable assembly 10 and the calibration board 12 is a concave structure, namely, a pin hole facilitates processing and reduces costs.

The following briefly describes a working process of the cable assembly calibration apparatus described in the foregoing embodiments with reference to of FIG. 1 to FIG. 6.

In a communications device, for example, a relatively large switch, first, multiple transversely inserted boards are fastened inside a housing of a chassis in a layered manner, then a calibration block 11 is installed and fastened, on the housing of the chassis, at an interface position corresponding to the transversely inserted board, then when a connector at one end of the cable assembly 10 is connected to a connector on the transversely inserted board, calibration and positioning are performed on the cable assembly 10 in an X direction and a Y direction by using the calibration block 11, to ensure smooth alignment and installation of the cable assembly 10 and the transversely inserted board. Then, a calibration board 12 is disposed at the other end of the cable assembly 10, and calibration and positioning is performed on the cable assembly 10 in the X direction and the Y direction by using the calibration board 12, to ensure smooth alignment and installation of the cable assembly 10 and a vertically inserted board. After assembly and calibration and positioning are completely performed on the cable assembly 10 by using the calibration block 11 and the calibration board 12, the cable assembly 10 is fastened on the chassis, so as to complete assembly of the communications device, so that signal interconnection between the transversely inserted board and the vertically inserted board is completed by using the cable assembly 10.

The foregoing descriptions are merely specific implementation manners of the present invention, but the protection scope of the present invention is not limited thereto. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A cable assembly calibration apparatus for calibrating a cable assembly, wherein the cable assembly comprises multiple cables and connectors placed at two ends of the cables, the cable assembly calibration apparatus comprising:
a calibration block and a calibration board configured to perform calibration and positioning on the cable assembly in both an X direction and a Y direction, the calibration block disposed at one end of the cable assembly, and the calibration board disposed at the other end of the cable assembly; and
a convex structure or a concave structure disposed on all surfaces, opposite to the cable assembly, of the calibration block and the calibration board, and the convex structure or the concave structure fits a calibration structure on the cable assembly to fasten the cable assembly.

2. The cable assembly calibration apparatus according to claim 1, wherein the calibration block comprises:
multiple first calibration bars, each first calibration bar configured to fasten the cable assembly in the X direction; and
at least one second calibration bar configured to fasten the cable assembly in the Y direction.

3. The cable assembly calibration apparatus according to claim 2, wherein the first calibration bar and the second calibration bar each comprise at least one cuboid stick, and the convex structure or the concave structure is disposed on the cuboid stick.

4. The cable assembly calibration apparatus according to claim 3, further comprising:
a first concave structure disposed on the first calibration bar, and correspondingly, a first convex structure matching the first concave structure disposed on the cable assembly; and
a second concave structure disposed on the second calibration bar, and correspondingly, a second convex structure matching the second concave structure disposed on the cable assembly.

5. The cable assembly calibration apparatus according to claim 4, wherein:
the first concave structure comprises a square groove conducted in a vertical direction of the cable assembly, and the first convex structure comprises a square bump configured to fit within the square groove; and
the second concave structure comprises a first pin hole, and the second convex structure comprises a first circular pin structure configured to fit within the first pin hole.

6. The cable assembly calibration apparatus according to claim 1, wherein:
the calibration board has a tabular structure shape and comprises:
an opening,
multiple rows of third concave structures, and
at least one row of fourth concave structures;
a third convex structure matching both the third concave structure and the fourth concave structure is disposed on the cable assembly;
the third concave structure and the fourth concave structure are arranged in a matrix form; and
the third concave structure is configured to fasten the cable assembly in the X direction, and the fourth concave structure is configured to fasten the cable assembly in the Y direction.

7. The cable assembly calibration apparatus according to claim 6, wherein:
the multiple rows of third convex structures are arranged in a matrix form and disposed on the calibration board;
a guide sleeve is disposed on the cable assembly; and
multiple rows of the third concave structures and at least one row of the fourth concave structures that fit the third convex structures are disposed on the guide sleeve.

8. The cable assembly calibration apparatus according to claim 7, wherein:
the third convex structure comprises a second circular pin structure;
the fourth concave structure comprises a second pin hole, and a gap exists between the second pin hole and the second circular pin in the Y direction of the cable assembly; and
the fourth concave structure comprises a third pin hole configured to accept the second circular pin.

9. A communication device, comprising:
a transversely inserted board;
a vertically inserted board;
a cable assembly comprising multiple cables and connectors placed at two ends of the cables; and
a cable assembly calibration apparatus, comprising,
a connector at one end of the cable assembly is connected to a connector on the transversely inserted board, a connector at the other end of the cable assembly is connected to a connector on the vertically inserted board,
a calibration block and a calibration board configured to perform calibration and positioning on the cable assembly in both an X direction and a Y direction, the calibration block disposed at one end of the cable assembly where the connector of the cable assembly that is connected with the connector on the transversely inserted board is disposed, the calibration board disposed at the other end of the cable assembly, and
a convex structure or a concave structure disposed on all surfaces, opposite to the cable assembly, of the calibration block and the calibration board, and the convex structure or the concave structure fits a calibration structure on the cable assembly to fasten the cable assembly.

10. The communication device according to claim 9, wherein the calibration block comprises:
multiple first calibration bars, each first calibration bar configured to fasten the cable assembly in the X direction; and
at least one second calibration bar configured to fasten the cable assembly in the Y direction.

11. The communication device according to claim 10, wherein the first calibration bar and the second calibration bar each comprise at least one cuboid stick, and the convex structure or the concave structure is disposed on the cuboid stick.

12. The communication device according to claim 11, further comprising:
a first concave structure disposed on the first calibration bar, and correspondingly, a first convex structure matching the first concave structure disposed on the cable assembly; and
a second concave structure disposed on the second calibration bar, and correspondingly, a second convex structure matching the second concave structure disposed on the cable assembly.

13. The communication device according to claim 12, wherein:
the first concave structure comprises a square groove conducted in a vertical direction of the cable assembly, and the first convex structure comprises a square bump configured to fit within the square groove; and
the second concave structure comprises a first pin hole, and the second convex structure comprises a first circular pin structure configured to fit within the first pin hole.

14. The communication device according to claim 9, wherein:
the calibration board has a tabular structure shape and comprises: an opening, multiple rows of third concave structures, and at least one row of fourth concave structures,
a third convex structure matching both the third concave structure and the fourth concave structure is disposed on the cable assembly;
the third concave structure and the fourth concave structure are arranged in a matrix form; and
the third concave structure is configured to fasten the cable assembly in the X direction, and the fourth concave structure is configured to fasten the cable assembly in the Y direction.

15. The communication device according to claim 14, wherein:
the multiple rows of third convex structures are arranged in a matrix form and disposed on the calibration board;
a guide sleeve is disposed on the cable assembly; and multiple rows of the third concave structures and at least one row of the fourth concave structures that fit the third convex structures are disposed on the guide sleeve.

16. The communication device according to claim 15, wherein:
the third convex structure comprise a second circular pin structure;
the fourth concave structure comprises a second pin hole, and a gap exists between the second pin hole and the second circular pin in the Y direction of the cable assembly; and
the fourth concave structure comprises a third pin hole configured to accept the second circular pin.
